(19) United States
(12) Patent Application Publication
(10) Pub. No.: US 2006/0155637 A1
(43) Pub. Date: Jul. 13, 2006

(54) Combined on-site and online auction systems and methods

(76) Inventors: Matthew Hawkes, Layton, UT (US); Harold Tyler, Centerville, UT (US)

Correspondence Address: KENNETH E. HORTON;KIRTON & MCCONKLE, 60 EAST SOUTH TEMPLE, SUITE 1800, SALTLAKE CITY, UT, 84111, US

(21) Appl. No.: 11/216,703

(22) Filed: Aug. 30, 2005

Related U.S. Application Data
(60) Provisional application No. 60/606,485, filed on Sep. 1, 2004.

(51) Int. Cl. G06Q 40/00

(52) U.S. Cl. 705/37

(57) ABSTRACT

Auction systems and methods for using such auction systems to sell items and conduct auctions are described. The auction systems contain an online auction system, an on-site auction system, or a combination thereof. The action system contains an item(s) for the auction(s) in a warehouse or other location physically accessible to the bidders. On-site bidders are able to inspect and bid on the items by using electronic stations or kiosks, either fixed or portable, that are located at the physical location (i.e., warehouse) and that are linked to an internal electronic network. The internal electronic network is also linked to an external electronic network, such as the Internet, that allows the auction to also proceed as an online auction. Both on-site and online bidders can therefore also bid on the items electronically. Using the auction system allows personal inspection and verification of the item(s) before participating in the auction process. As well, the auction system can allow a third party inspection and/or validation of item.

### CROSS-REFERENCE TO RELATED APPLICATION

This application claims priority of U.S. patent application Ser. No. 60/606,485, filed Sep. 1, 2004, the entire disclosure of which is incorporated herein by reference.

### FIELD OF THE INVENTION

The invention relates to an auction system and methods for using such an auction system. More particularly, the invention relates to an auction system that can contain an online auction component and on-site auction component and methods for using such an auction system to conduct an online and on-site auction at the same time.

### BACKGROUND OF THE INVENTION

In-person or on-site auction systems have been known for many years. In these auctions, the seller(s) sets an item (or several items) out for display. The potential buyer(s) have the opportunity to personally inspect the items that are being auctioned to determine their condition. The auction is then carried out and the numerous bidders compete with each other to purchase the item. These auction systems, however, are inefficient in that the bidders must be physically present to inspect and/or bid on the item. In other words, they must be physically present when the item is being auctioned off, leading to a limited audience which can participate in the auction. As well, only a single item is usually auctioned at any given time.

There are many types of electronic auction systems that have been recently developed which overcome these problems associated with in-person auctions. Typically, the electronic auction systems are carried out using some type of electronic system (i.e., the Internet) and so are often called online auctions. One of the most famous online auction systems is EBAY®. In most online auction systems, a seller decides to auction an item by creating an account or listing for that item. The seller lists the relevant information about item for sale and all other pertinent auction parameters (such as a minimum price, bid increments, closing time, etc. . . . ). One or more buyers (or bidders) are then able to electronically view the auction, the auction parameters, and all other listed information. The bidders then bid against each other and the highest bid wins the auction. Numerous auctions can proceed at the same time, unlike an in-person auction. Once the buyer has paid the purchase price (as well as any shipping charges and taxes), the seller packages the item for shipping and sends the item to the buyer. See U.S. Pat. Nos. 6,859,787, 6,778,993, 6,748,422, 6,732,161, 6,604,107, 6,523,037, 6,466,917, 6,415,320, and 6,058,417, the disclosures of which are incorporated herein by reference.

In online auction systems, however, the bidders typically do not have the ability to personally view or personally inspect the item before purchasing it and/or bidding on it. While in some instances the seller will place an actual picture of the item in the listing, there is often no requirement for such a feature. And even if a picture is listed, the bidder and/or buyer can not verify whether the picture listed is an actual depiction of the item for sale.

A related problem for online auctions systems is that there is no type of third party inspection or validation of the item. The accuracy of the auction listing for the item is completely dependent on the seller. Thus, the bidder and/or buyer must often take the seller at face value and trust that the item being auctioned is as described and is in the condition described. Such a situation lends itself to fraud, miscommunication, and/or quality issues.

Yet another problem occurs when items are damaged during shipping. After the auction is concluded, the seller packages and ships the item to the winning bidder. In certain instances, the item is not packaged correctly before being shipped to the buyer. During transit, the item can be damaged due to the deficient packaging. As well, even if the packaging is sufficient, the item can be damaged by the shipping company.

Still another problem is fraud. In some instances, certain individual sellers intentionally list an item and then collect the payment, but either have no item to ship, intentionally do not ship the item, or even ship the item in a condition other than as listed. While some auction systems have been modified to combat such fraud, they only been partially successful and therefore have only slightly reduced the fraud, but have not been able to eliminate it.

### SUMMARY OF THE INVENTION

The invention relates to auction systems and methods for using such auction systems to sell items and conduct auctions. The auction systems contain an online auction component, an on-site auction component, or a combination of these components. The items for the auction are located in a warehouse or other location physically accessible to the bidders. On-site bidders are able to inspect and bid on the items by using electronic stations or kiosks, either fixed or portable, that are located at the physical location (i.e., warehouse) and that are linked to an internal electronic network. The internal electronic network is also linked to an external electronic network, such as the Internet, that allows the auction to also proceed as an online auction. Both on-site and online bidders can therefore also bid on the items electronically. Using the auction system allows personal inspection and verification of the item(s) before participating in the auction process. As well, the auction system can allow a third party inspection and/or validation of item.

### BRIEF DESCRIPTION OF THE DRAWINGS

The following description of the invention can be understood in light of the Figures, in which:

FIG. 1 depicts an auction system in one aspect of the invention; and

FIG. 2 illustrates a portion of the auction method in one aspect of the invention.

The Figures presented in conjunction with this description are views of only particular—rather than complete—portions of the auction systems and associated methods according to the invention. Together with the following description, the Figures demonstrate and explain the principles of the invention. In the Figures, the thickness of lines and regions may be exaggerated for clarity. The same reference numerals in different drawings represent the same element, and thus their descriptions will be omitted.

### DETAILED DESCRIPTION OF THE INVENTION

The following description provides specific details in order to provide a thorough understanding of the invention. The skilled artisan, however, would understand that the invention can be practiced without employing these specific details. Indeed, the invention can be practiced by modifying the illustrated system and can be used in conjunction with techniques conventionally used in the industry. The invention described below deals primarily with the auction system in a warehouse or large building. The invention, however, could be modified for any location(s) where bidders and/or third parties can personally inspect the item before and/or during the auction.

The invention includes an auction system that allows for an on-site auction process, an online auction process, or a combination of both processes. The auction system therefore allows an electronic bidding process whether on-site or online, personal inspection of items before bidding, as well as optional third party validation of the items during the auctioning process. Any auction system that operates to provide these functions can be used in the invention, including the auction system described below and depicted in the Figures.

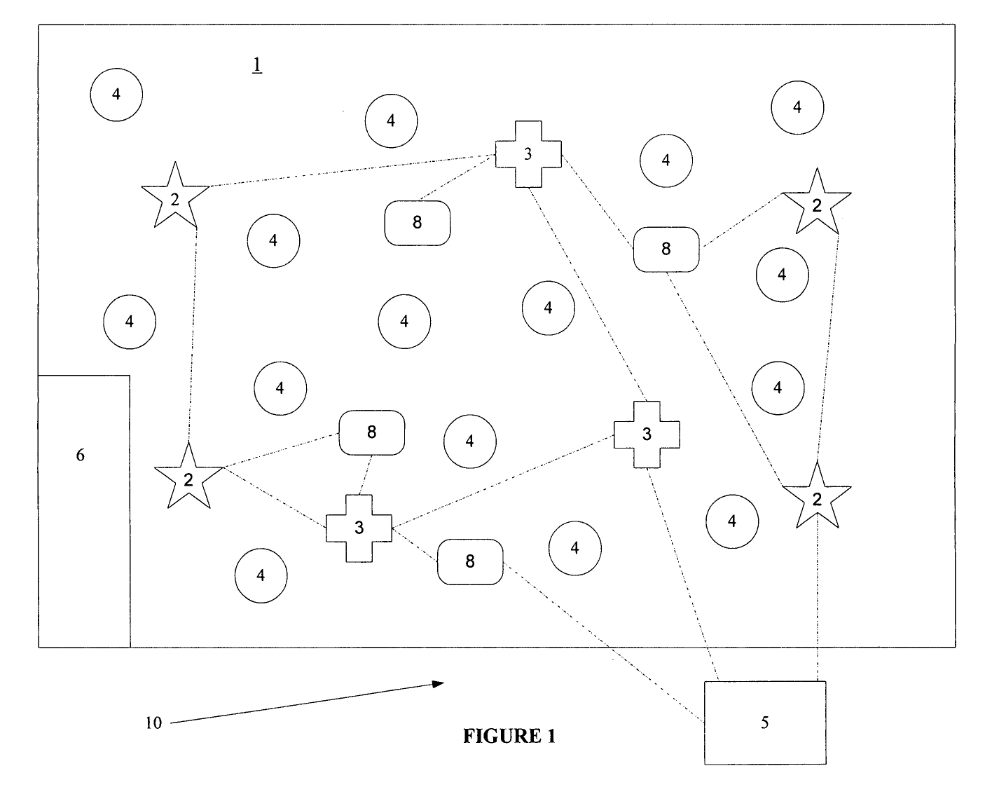

In one aspect of the invention, the auction system 10 contains the components depicted in FIG. 1. In this aspect of the invention, the auction system comprises a warehouse (or other large facility) 1. The warehouse 1 contains a section 6 for a seller to deliver an item(s) 4 to the warehouse 1. The seller can deliver the item 4 personally, such as by dropping off the item 4, or by shipping the item 4 to the warehouse.

When the item 4 is delivered to the warehouse 1, the seller (or someone acting on his behalf such as his agent, the operator of the warehouse 1, or any other third party) can then prepare the item 4 for the auction. The item 4 can be prepared using any known process in the art. For example, the item could be prepared by defining the terms of the auction and the parameters of the auction under which the item will be sold (i.e., price, item description, starting date, end date, etc. . . . ). In one aspect of the invention, the operator of the auction system 10 can assist in preparing the item for auction by performing these functions, as well as other functions such as cleaning or fixing the item.

The types of items 4 that can be auctioned are virtually unlimited. Often, the types of items that can be auctioned depend on what the individual sellers have. Typically, however, mostly consumer products will be sold via the auction system and method. In one aspect of the invention, the operator of the auction system can act as a seller and sell products via the auction system, including her own branded products or branded products of other parties. Thus, the operator of the auction system can act as a seller in this aspect of the invention.

Once the item 4 has been received and prepared for the auction, it can be delivered to any desired location in the warehouse 1. In one aspect of the invention, the warehouse 1 can be divided into sections according to any desired criteria, such as price, type of item, geography of seller, or any other criteria. If desired, the terms and other information about the auction of the item can be posted or listed near the item.

Once in the desired location, individual bidders can come and personally inspect and/or view the item in that location in the warehouse. The individuals that can inspect and view the item are virtually unlimited. In one aspect of the invention, the individuals are limited to those who meet specific criteria, such as those who have proven that they have sufficient funds to purchase the given item. As well, the individuals could be limited to those who joined a membership club that is required by the operator of the auction system 10. As well, the sellers could also be limited to those individuals who have joined such a membership club.

The warehouse 1 may be equipped with means for viewing the item and other auction information (including pictures and/or videos) for those not able to personally view or inspect the item. Examples of such individuals include those not physically located in the warehouse, such as a remote user or bidder. Any viewing means 8 that allows a remote user to view the item without being physically present can be used, including cameras, video cameras, video surveillance equipment, or the like. The viewing means 8 can be located throughout the warehouse at various locations as shown in FIG. 1, including being located close to specific items, so that numerous types of views (including a close-up view) from various locations is possible by the remote user. Optionally, the viewing means can contain any known control mechanism so that the operator or a remote user can control any specific viewing means to change its view.

The auction system also contains means for bidding on the item(s) up for auction. The bidding means allows either the on-site user or a remote user to electronically bid on the item. Any means known in the art that operates with this function can be used in the auction system, including electronic bidding means such as a WAP enabled cell phone, kiosks, wireless PDAs, desktop and laptop computers, as well as any of those means described in the patents listed above.

In one aspect of the invention, the bidding means comprises an electronic kiosk 3. Electronic kiosks, also known as multimedia kiosks, have been used for many years. As known in the art, electronic kiosks usually contain any mechanism for allowing an individual to access the electronic system to which the kiosk is connected. Any kiosk operating to achieve this function can be used in the invention, including the R-Scan Touch Terminal kiosk.

Typically, the kiosk 3 used in the invention can contain a touch screen, credit card reader, and receipt printer, and the like. The electronic kiosk can also contain any other component that would enable it to operate as described herein, including a bar-code scanner and a thermal printer. The electronic kiosks are located in the warehouse 1 in any desired location(s) and with sufficient numbers to allow customers to quickly place, check, and update bids for any number of items.

The electronic kiosks are typically in a fixed location(s) in the warehouse 1, but can be made slightly mobile (i.e., by installing wheels on the base). In another aspect of the invention, however, the bidding means can also be portable. Using a portable bidding means allows a user to move around the warehouse 1 and view and bid on numerous items. Any suitable portable electronic device 2 which exhibits such a functions and allows a user to bid while being portable can be used in the invention. Examples of such portable electronic devices include personal digital assistants (PDAs), laptop computers, cell phones, and other wireless devices.

The bidding means (whether portable or fixed) are linked to together and linked to an electronic system within the warehouse. As shown in FIG. 1 by the dotted line, the fixed or portable bidding means can be linked to each other within a single electronic system that is enclosed within warehouse 1. In another aspect of the invention, the bidding means can be linked internally within the auction system by being linked to other warehouses and/or the electronic systems within those warehouses. The viewing means 8 are also linked to the electronic system and the information captured by the viewing means can be therefore sent electronically to a remote user.

The auction system also contains any components or elements that—when combined—allow it to carry out the auction process. Thus, the auction system 10 contains data in any electronic format that can be manipulated and used by the auction system to carry out the bidding process. In one aspect of the invention, a database is used to contain the data. The database contains all the information about the various items and the progression of the auction for each item. Any database known in the art that operates in the above manner can be used in this aspect of the invention, including Microsoft Access.

The auction system 10 operates using any computer operating system that is compatible with the database that is selected. In one aspect of the invention, such as where Microsoft Access is used, the operating system that is used is Microsoft Windows. Of course, any other operating system that is compatible with Microsoft Access could be used in this aspect of the invention. Where other databases are used, other operating systems may be used in the invention. Examples of such other operating systems include Apple OS, Unix, and Linux.

The auction system of the invention can use any compatible computer programming language. In one aspect of the invention, where Microsoft Access and Windows is used, the computer language is Visual Basic for Applications (VBA). Of course, other computer languages and programming languages could be used that are compatible with the database and operating system chosen.

The auction system 10 also contains any known computer hardware capable of running the selected database, operating system, and computer language. Examples of such hardware include desktop personal computers, laptop computers, notebook computers, tablet personal computers, personal digital assistants (PDAs), workstations, and servers. In one aspect of the invention, a SQL Server is used as part of the hardware for the system.

The various components of the electronic system—including the bidding means and the viewing means—are electronically connected to each other using any means known in the art. Examples of electronic connection means include a network, such as a local area network (LAN) or a wide area network (WAN), dial-in-connections, cable, optical, infrared, radio frequency and microwave communications, special high-speed ISDN lines, wireless, and/or satellite communication media. This internal network can then be connected to any external network as known in the art so that the bidding means are indirectly linked to the external network.

In one aspect of the invention, the bidding and viewing means can be directly linked to an external electronic system, as shown by 5 in FIG. 1. The external electronic system can be the Internet (thereby connecting to a remote bidder), another online auction system (like EBay), or web sites of other retailers (like Costco). Thus, remote bidders can then access the auction system, regardless whether they are at another warehouse or any other location. When the remote bidder accesses the auction system over the Internet, the auction is performed similar to other online auction systems.

By using this configuration and linking the auction system to external electronic systems, the auction process can be performed internally in the warehouse, externally, or both. Thus, the auction process can provide both the benefits of an online auction system and an on-site auction system.

As well as the auction system, the invention also includes an auction method that allows for an on-site auction process, an online auction process, or a combination of both. The auction method begins when the items 4 are received, prepared for the auction, and moved to the desired location in the warehouse 1. The auction information about each item is kept with the item and also placed into the database of the auction system 10.

Next, the on-site users and remote users are then allowed to view and examine the items before (and during) the bidding begins. On-site users can come to the warehouse (or other facility) and personally inspect the items they are interested in and browse through all the items if desired. Like remote users, they can also browse the items electronically using the bidding means. With each item, the associated auction parameters set by the seller are located near the item and/or in the bidding means, so that both the on-site user and the remote user know the details of the item as well as the parameters of the auction (i.e., current bid, condition, time left in auction, etc., . . . ). Optionally, a given time period is set for both on-site and remote users to personally or remotely view the item(s). Once this time period has concluded, the bidding process begins.

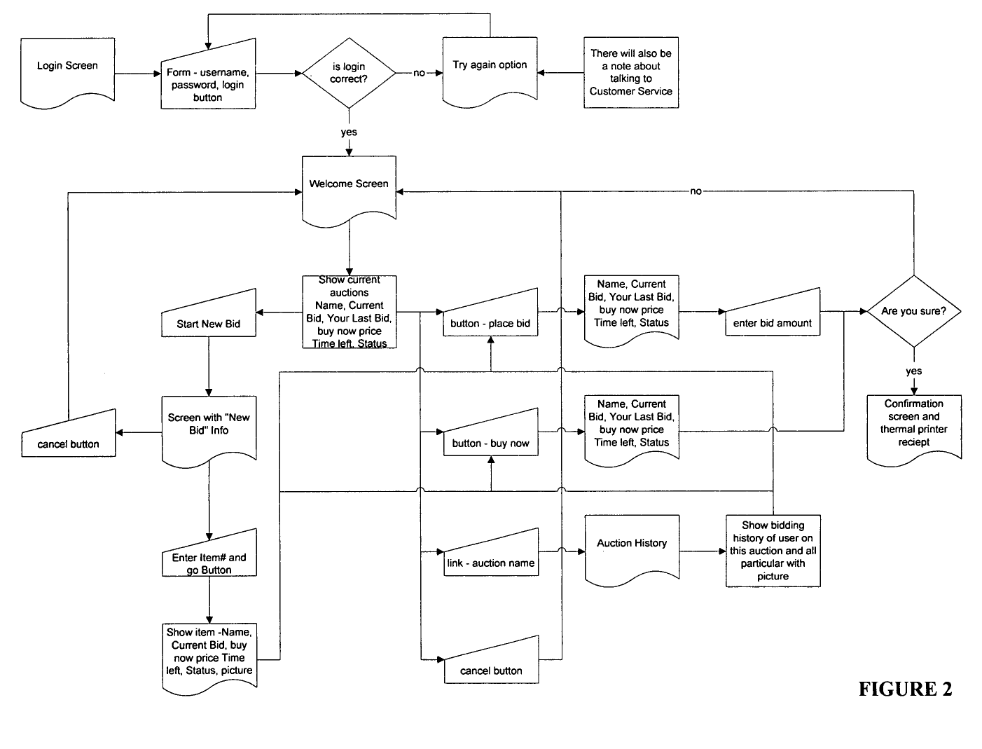

In the bidding process, the on-site users utilize the on-site bidding means, whether fixed or portable, to bid on any given item. Thus, the on-site user can bid using the fixed locations (such as by using the auction kiosk 2) or a portable location within the warehouse (such as by a portable electronic device 3). Remote users can bid as well since they are connected to the auction system 10 and can access the bidding means. The details of operating the bidding means are depicted in FIG. 2.

The auction is performed electronically. In other words, unlike in-person auction systems, there is not an auctioneer for each specific item. Rather, each item is in the auction process is set up in the electronic system and the bidders electronically bid against each other using the bidding means. This bidding process can be performed either on-site (in the warehouse 1 using the bidding means) or remotely as described above.

In one aspect of the invention, using the electronic kiosks (or auction kiosks) can be advantageous. When not in use, the screen of the auction kiosk can change to an information or advertising mode to show other items for auction, information about the warehouse, or any other material desired by the operator of the auction system 10. When the screen of the auction kiosk is activated, such as by being touched, it shows a login screen.

To use the auction kiosk, the user accesses the login screen which will ask for login information, such as a login ID and a password. If a membership has been created, the user/member can use that information manually or electronically using a membership card as known in the art. Alternatively, a guest login ID and password can be used for non-members. Other login options as known in the art can also be used in place of—or in addition to—this login process. In another aspect of the invention, no login information is required and the user can directly access the information in the auction kiosk.

Once the user has accessed the auction kiosk, a list of all the pending auctions or a specific category of auctions can be listed and viewed. The auction for each item will list the following information: the auction name or auction title; a small/large depiction or video of the item; the current bid; time remaining until close of auction; the bidding history; related items for auction; seller information; etc. . . . . As well, any other auction information or auction parameters can be listed.

Similar to other online auctions, the current winning bid is displayed so that other users may decide whether they would like to bid. Based on this information, the user can decide whether to enter a bid for any specific item. If a bid is placed, an electronic receipt can be sent to the remote user or the on-site user. For the on-site user, a paper receipt can be printed from the auction kiosk and used to verify the bid.

The bidding process continues until the time period allotted for the auction for any item(s) has concluded. At this point, the auction is concluded and the highest bidder (now the purchaser) of the item is then notified. If desired, the purchaser can arrange to have the item shipped to a specific address, especially if the purchaser participated in the auction via the Internet. Alternatively, the purchaser can pay for the item at the warehouse and pick it up physically, minimizing the chance for damage to the item during the shipping process.

In one aspect of the invention, the auction system and method can be configured so that only members of the auction system can participate. In other words, before becoming a bidder or a seller, an individual must sign up as a member of the auction system. Thus, the operator of the auction system can better control the quality of the auction process and validation of the items for sale.

In another aspect of the invention, the seller is eliminated in this process. In this aspect of the invention, the operator(s) of the auction warehouse can put up retail items to be auctioned off. In another aspect of the invention, both the owner/operator of the warehouse 1 and the individual member sellers can put items up for auction simultaneously.

In another aspect of the invention, the auction system and method can be integrated to become a part of another online auction. As well, another online auction system and process could become part of the auction system and method described herein. In both instances, the auction system described above is modified such it can integrate with the other online auction system as known in the art.

Using the invention as described herein provides several advantages. First, unlike other on-line auction systems, a personal inspection or virtual inspection by the viewing means of the item to be purchased is available. As mentioned above, this is currently not offered by many on-line auction systems. As well in the present auction system, a third party (such as the operator of the warehouse) can optionally validate the item (and its condition) before it is auctioned. In other on-line auction systems, there is not a third party or intermediary which can validate the item: the transaction is directly between the buyer and seller.

Having described the preferred aspects of the invention is it understood that that invention defined by the appended claims is not to be limited by particular details set forth in the above description, as many variations thereof are possible without departing from the spirit or the scope thereof.

We claim:

1. A system for auctioning an item to a user, the system comprising:
means for a bidder to view an item to be auctioned; and
means for a user to electronically bid on the item, the bidding means being located in the proximity of the item.

2. The system of claim 1, wherein the bidding means is in a substantially fixed location relative to the item.

3. The system of claim 2, wherein the bidding means comprises an electronic kiosk.

4. The system of claim 3, wherein the user is located in the same proximity as the item.

5. The system of claim 1, wherein the user is located remote from the item.

6. The system of claim 5, wherein the viewing means comprises a video camera.

7. The system of claim 5, wherein the bidding means is connected to an electronic system accessible to the remote user.

8. The system of claim 1, wherein the bidding means is electronically connected to one other such bidding means.

9. The system of claim 1, further comprising means for third-party inspection or validation of item.

10. A method for electronically auctioning an item to a user, comprising:
providing an item to be auctioned;
providing means for a bidder to inspect the item; and
providing electronic bidding means.

11. The method of claim 10, wherein the electronic bidding means are in a substantially fixed location relative to the item.

12. The method of claim 10, wherein the electronic bidding means are portable and operate proximate the item.

13. The method of claim 10, wherein the electronic bidding means are connected to an external electronic system.

14. The method of claim 10, further comprising means for third-party inspection or validation of item.

15. A method for purchasing an item in an auction, comprising:
providing means for electronically bidding in an auction, the bidding means located proximate an item to be auctioned and electronically connected to one other device; and
using the electronic bidding means to bid in the auction.

16. The method of claim 15, wherein the electronic bidding means are in a substantially fixed location relative to the item.

17. The method of claim 15, wherein the electronic bidding means are portable and operate proximate the item.

18. The method of claim 15, wherein the electronic bidding means are connected to an external electronic system.

19. The method of claim 15, further comprising means for third-party inspection or validation of item.

20. The system of claim 1, wherein the bidding means comprises a portable electronic device.
